(19) United States
(12) Patent Application Publication
(10) Pub. No.: US 2021/0345606 A1
(43) Pub. Date: Nov. 11, 2021

(54) WEAKLY ALKALINE PERACETIC ACID SOLUTION

(71) Applicant: Shandong Zhuojian Medical Technology Co.,Ltd., Dezhou City (CN)

(72) Inventors: Dandan Wang, Dezhou City (CN); Xiangpeng Fu, Dezhou City (CN)

(21) Appl. No.: 17/173,407

(22) Filed: Feb. 11, 2021

(30) Foreign Application Priority Data
May 8, 2020 (CN) 202010382929.0

(51) Int. Cl. A01N 25/02; A01N 59/00; A01N 25/30; A01N 25/22

(52) U.S. Cl. CPC A01N 25/02; A01N 25/22; A01N 25/30; A01N 59/00

(57) ABSTRACT

The present disclosure relates to a weakly alkaline peracetic acid solution. The present disclosure provides a weakly alkaline peracetic acid solution, comprising a liquid A agent and a powder B agent, the powder B agent being in an amount of 17-23 g relative to per liter of the liquid A agent, wherein the liquid A agent comprises the following components in percentage by mass: 10-20% of hydrogen peroxide with a concentration of 30%, 1-15% of a stabilizer, 0.1-5% of a metal ion chelating agent, 1-10% of an antioxidant, 0.5-2% of a surfactant, and 53-87.4% of deionized water; and the powder B agent comprises the following components: 5-20% of a stabilizer, 5-20% of a corrosion inhibitor, 1-30% of a pH regulator, and 20-50% of an oxide.

### CROSS REFERENCE TO RELATED APPLICATION

This application claims the priority of Chinese Patent Application No. 202010382929.0, entitled “Weakly alkaline peracetic acid solution” filed with the China National Intellectual Property Administration on May 8, 2020, which is incorporated herein by reference in its entirety.

### TECHNICAL FIELD

The present disclosure relates to the technical field of sterilization articles, and in particular to a weakly alkaline peracetic acid solution, which is suitable for the high-level disinfection and sterilization of medical instruments and flexible endoscopes.

### BACKGROUND

Because of its special structure, the flexible endoscopes cannot be sterilized by moist heat, and only can be sterilized by chemical disinfectants. In terms of conventional chemical disinfectants such as glutaraldehyde, ortho-phthalaldehyde and peracetic acid, due to the defects of the disinfectants itself, such as long sterilization time, strong odor, gray staining and corrosiveness, they are obviously restricted during the use. For example, regarding glutaraldehyde, its tolerance to mycobacteria has been reported many times in recent years, and its exposure value in the toxicity environment has been paid more and more attention. It is reported that workers who have been engaged in glutaraldehyde disinfection for a long time may suffer from various occupational diseases to varying degrees. Regarding the ortho-phthalaldehyde, it is used in a low concentration, and there is no resistant bacteria at present; however, it cannot be used to sterilize, and as a result, the ortho-phthalaldehyde cannot be used for some flexible endoscopes which need to be sterilized.

In recent years, the peracetic acid on the market has emerged in endlessly. The conventional peracetic acid has two-component packages, i.e. A agent and B agent, the A agent and B agent being mixed for 24 hours before use, and then, after the reaction is completed, the reactants are diluted in proportion for the use. Such peracetic acid has characteristics of strong corrosive, and pungent odor that is irritating to the human body. Moreover, most of the new monadic peracetic acid on the market are obtained by the reaction of hydrogen peroxide and acetic acid in the presence of a catalyst, in which a large amount of stabilizers and corrosion inhibitors need to be added. However, most of the obtained monadic peracetic acid has a pH value between 1-2, presenting strong acidity, and thus still has strong corrosive. Also, because the acetic acid is used in a large amount, after the reaction, there still remain some acetic acid, leading to a strong pungent odor.

### SUMMARY

In order to solve the defects of the peracetic acid in the prior art, such as strong corrosive and pungent odor, an objective of the present disclosure is to provide a weakly alkaline peracetic acid solution.

In order to achieve the above objective, the present disclosure provides the following technical solutions:

A weakly alkaline peracetic acid solution, comprising a liquid A agent and a powder B agent, the powder B agent being in an amount of 17-23 g relative to per liter of the liquid A agent, wherein

the liquid A agent comprises the following components in percentage by mass:

10-20% of hydrogen peroxide with a concentration of 30%,

1-15% of a stabilizer,

0.1-5% of a metal ion chelating agent,

1-10% of an antioxidant,

0.5-2% a of surfactant, and

53-87.4% of deionized water;

and the powder B agent comprises the following components in percentage by mass:

5-20% of a stabilizer,

5-20% of a corrosion inhibitor,

1-30% of a pH regulator, and

20-50% of an oxide.

In some embodiments, the stabilizer in the liquid A agent is at least one selected from the group consisting of citric acid, malic acid, lactic acid, phosphoric acid, hydroxyethylidene diphosphonic acid and o-hydroxybenzoic acid.

In some embodiments, the metal ion chelating agent is at least one selected from the group consisting of ethylenediaminetetraacetic acid, aminotriacetic acid, 8-hydroxyquinoline, dithizone, ethylenediamine, ammonium citrate, and potassium sodium tartrate.

In some embodiments, the antioxidant is at least one selected from the group consisting of sodium sulfite, sodium metabisulfite, sodium bisulfite, and sodium thiosulfate.

In some embodiments, the surfactant is at least one selected from the group consisting of fatty alcohol-polyoxyethylene ether, Tween 80, Span 85, propylene glycol block polyether, lauryl sulfate triethanolamine, and nonylphenol ethoxylates.

In some embodiments, the conductivity of the deionized water is less than 1.5 μs/s.

In some embodiments, the stabilizer in the powder B agent is at least one selected from the group consisting of sodium phosphate, sodium pyrophosphate, sodium hexametaphosphate, sodium bisulfite, sodium metabisulfite, and sodium thiosulfate.

In some embodiments, the corrosion inhibitor is at least one selected from the group consisting of benzotriazole, tolyltriazole, mercaptobenzothiazole, sodium ethylenediamine tetramethylenephosphonate, and ethylenediamine tetramethylene phosphoric acid.

In some embodiments, the pH regulator is at least one selected from the group consisting of sodium carbonate, sodium bicarbonate, sodium hydroxide, sodium dihydrogen phosphate, disodium hydrogen phosphate, potassium dihydrogen phosphate, and dipotassium hydrogen phosphate.

In some embodiments, the oxide is at least one selected from the group consisting of sodium percarbonate, sodium peroxide, potassium peroxide, calcium peroxide, magnesium peroxide, peroxide calcium, zinc peroxide, and potassium persulfate.

The present disclosure further provides a method for preparing the weakly alkaline peracetic acid solution, comprising the following steps: mixing the liquid A agent and the powder B agent, stirring uniformly, and standing for 10 minutes to form a peracetic acid solution.

The present disclosure has the following beneficial effects: raw materials according to the present disclosure do not include strong acidic substance such as acetic acid and sulfuric acid, and thus the peroxyacetic acid solution obtained from them exhibits small odor, especially no pungent odor caused by acetic acid and sulfuric acid. Moreover, after mixing the liquid A agent and the powder B agent, the resulting mixture has a pH value of 7.45, presenting weakly alkaline. Without any corrosion inhibitor, the peroxyacetic acid solution is basically non-corrosive to stainless steel, carbon steel, copper and aluminum. After being compounded, the peroxyacetic acid solution might be used continuously to achieve sterilization within 10 minutes , and high-level disinfection within 5 minutes.

### DETAILED DESCRIPTION

The following specific examples illustrate the embodiments of the present disclosure, and those skilled in the art could easily understand the other advantages and functions of the present disclosure from the contents disclosed in this specification.

### Example 1

The embodiment provided a weakly alkaline peracetic acid solution, comprised a liquid A agent and a powder B agent, wherein the volume of the liquid A agent was 5 L, and the mass of the powder B agent was 100 g, wherein

the liquid A agent comprised the following components in percentage by mass:

15.0% of hydrogen peroxide with a concentration of 30%,

10.0% of o-hydroxybenzoic acid,

1.0% of citric acid,

1.0% of 8-hydroxyquinoline,

1.0% of sodium bisulfite,

2.0% of fatty alcohol-polyoxyethylene ether,

70.0% of deionized water, with a conductivity of less than 1.5 μs/s,

and the powder B agent comprised the following components in percentage by mass:

10.0% of sodium phosphate,

10.0% of benzotriazole,

20.0% of sodium hydroxide,

10.0% of sodium carbonate,

50.0% of sodium percarbonate.

### Example 2

The embodiment provided a weakly alkaline peracetic acid solution, comprised a liquid A agent and a powder B agent, wherein the volume of the liquid A agent was 5 L, and the quality of the powder B agent was 100 g, wherein

the liquid A agent comprised the following components in percentage by mass:

20.0% of hydrogen peroxide with a concentration of 30%,

10.0% of citric acid,

5.0% of hydroxyethylidene diphosphonic acid,

1.0% of ammonium citrate,

5.0% of sodium thiosulfate,

2.0% of Tween 80

57.0% of deionized water, with a conductivity of less than 1.5 μs/s,

and the powder B agent comprised the followingcomponents in percentage by mass:

10.0% of sodium phosphate,

15.0% of benzotriazole,

15.0% of sodium hydroxide,

10.0% of sodium carbonate,

50.0% of sodium percarbonate.

The method for preparing the weakly alkaline peracetic acid solution in example 1 and example 2 comprised the following steps: the liquid A agent and the powder B agent were mixed and stirred uniformly in a container, and then the resulting mixture was stood for 10 minutes, to form the peracetic acid solution.

The obtained weakly alkaline peracetic acid solution had a content of the peracetic acid of 0.20% by mass, and a pH value of 7.45; after holding the peracetic acid at an ambient temperature of 54° C. for 14 days, the pH value reduced by 5.6%. By actual operation, after applying the weakly alkaline peracetic acid solution to the the spores of Bacillus subtilis black variant for 10 minutes, the sterilization level could be reached, which met the hygiene requirements of peroxide disinfectants.

At the same time, the peracetic acid according to the present disclosure could be directly decomposed into carbon dioxide and water after being used, which would not pollute the environment and would not require special sewage treatment.

The ordinary peracetic acid is generally synthesized by reacting hydrogen peroxide with acetic acid in the presence of catalysis of concentrated sulfuric acid, and it per se has strong acidity. Because the reaction is a reversible chemical reaction, in order to ensure the stability of the product, the product is essentially a mixture of peracetic acid, acetic acid and concentrated sulfuric acid, and thus it has strong pungent odor and strong metal corrosiveness.

The peracetic acid solution according to the present disclosure is in the form of weakly alkaline. After mixing the liquid A agent and the powder B agent, the resulting mixture has a pH value of 7.45. The peracetic acid solution will be strong corrosive to metals under the acidic condition, but will not be so corrosive to metals under neutral to weakly alkaline conditions. The peracetic acid solution according to the present disclosure is basically non-corrosive to stainless steel, carbon steel, copper and aluminum. Moreover, there is no acidic liquids with irritating odor such as acetic acid introduced into the reaction, much less stronger acidic liquid such as sulfuric acid. Furthermore, in the reaction the proportion of each material is strictly controlled to ensure the stability of the product.

The above examples are only the preferred embodiments of the present disclosure, and other embodiments that could achieve the technical solutions of the present disclosure by basically the same means also fall within the protection scope of the present disclosure.

What is claimed is:

1. A weakly alkaline peracetic acid solution, comprising a liquid A agent and a powder B agent, the powder B agent being in an amount of 17-23 g relative to per liter of the liquid A agent, wherein
the liquid A agent comprises the following components in percentage by mass:
10-20% of hydrogen peroxide with a concentration of 30%,
1-15% of a stabilizer,
0.1-5% of a metal ion chelating agent,
1-10% of an antioxidant,
0.5-2% of a surfactant, and
53-87.4% of deionized water;
and the powder B agent comprises the following components in percentage by mass:
5-20% of a stabilizer,
5-20% of a corrosion inhibitor,
1-30% of a pH regulator, and
20-50% of an oxide.

2. The weakly alkaline peracetic acid solution as claimed in claim 1, wherein the stabilizer in the liquid A agent is at least one selected from the group consisting of citric acid, malic acid, lactic acid, phosphoric acid, hydroxyethylidene diphosphonic acid and o-hydroxybenzoic acid.

3. The weakly alkaline peracetic acid solution as claimed in claim 1, wherein the metal ion chelating agent is at least one selected from the group consisting of ethylenediamine tetraacetic acid, aminotriacetic acid, 8-hydroxyquinoline, dithizone, ethylenediamine, ammonium citrate, and potassium sodium tartrate.

4. The weakly alkaline peracetic acid solution as claimed in claim 1, wherein the antioxidant is at least one selected from the group consisting of sodium sulfite, sodium metabisulfite, sodium bisulfite, and sodium thiosulfate.

5. The weakly alkaline peracetic acid solution as claimed in claim 1, wherein the surfactant is at least one selected from the group consisting of fatty alcohol-polyoxyethylene ether, Tween 80, Span 85, propylene glycol block polyether, lauryl sulfate triethanolamine, and nonylphenol ethoxylates.

6. The weakly alkaline peracetic acid solution as claimed in claim 1, wherein the conductivity of the deionized water is less than 1.5 μs/s.

7. The weakly alkaline peracetic acid solution as claimed in claim 1, wherein the stabilizer in the powder B agent is at least one selected from the group consisting of sodium phosphate, sodium pyrophosphate, sodium hexametaphosphate, sodium bisulfite, sodium metabisulfite and sodium thiosulfate.

8. The weakly alkaline peracetic acid solution as claimed in claim 1, wherein the corrosion inhibitor is at least one selected from the group consisting of benzotriazole, tolyltriazole, mercaptobenzothiazole, sodium ethylenediamine tetramethylenephosphonate, and ethylenediamine tetramethylene phosphoric acid.

9. The weakly alkaline peracetic acid solution as claimed in claim 1, wherein the pH regulator is at least one selected from the group consisting of sodium carbonate, sodium bicarbonate, sodium hydroxide, sodium dihydrogen phosphate, disodium hydrogen phosphate, potassium dihydrogen phosphate and dipotassium hydrogen phosphate.

10. The weakly alkaline peracetic acid solution as claimed in claim 1, wherein the oxide is at least one selected from the group consisting of sodium percarbonate, sodium peroxide, potassium peroxide, calcium peroxide, magnesium peroxide, peroxide calcium, zinc peroxide, and potassium persulfate.
